(19) United States
(12) Patent Application Publication
(10) Pub. No.: US 2010/0145492 A1
(43) Pub. Date: Jun. 10, 2010

(54) Automated Custom Design Generation

(75) Inventor: Jeffrey Craig Russell, Everett, WA (US)

Correspondence Address: Thompson Hine LLP, 10 West 2nd Street, 2000 Courthouse Plaza, NE, Dayton, OH, 45402-1758, US

(73) Assignee: The Boeing Company, Chicago, IL (US)

(21) Appl. No.: 12/331,297

(22) Filed: Dec. 9, 2008

(51) Int. Cl. G06F 19/00

(52) U.S. Cl. 700/103; 700/97; 700/107

(57) ABSTRACT

A method includes obtaining a custom specification that describes at least one option for the product, obtaining predefined configuration data that includes a commodity feature definition that describes a plurality of commodities associated with the product, a commodity interface definition that describes interface requirements among said plurality of commodities, a design table that associates said commodity feature definition and said commodity interface definition for a commodity; and a hierarchy of said plurality of commodities, generating the design configuration as a function of said custom specification and said predefined configuration data, wherein said hierarchy of said plurality of commodities controls order in which said plurality of commodities are applied to said product for automatic generation of the design configuration and said commodity interface definition with said design table ensure coordination among said plurality of commodities.

### FIELD

The present patent application is directed to automated generation of design configurations and, more particularly, to automated generation of custom design configurations for complex systems, such as airplanes.

### BACKGROUND

Designs or configurations for complex products or environments, such as airplanes, ships, or even buildings, include with hundreds of thousands or even millions of options, resulting in billions of possible option combinations. Even seemingly basic parts or modules of such products may have hundreds or thousands of individual features. One difficulty may lie in creating a coherent design solution or configuration from the multitude of options such that the design conforms to the engineering constraints or limitations of the product and that can be implemented in an efficient manner within a limited time frame.

Design of such complex products is further complicated when customers or consumers of the designed product are allowed to elect particular features or options to create a customized configuration Typically, customers, whether individuals or organizations, prefer custom products, designed to their specific requirements, over standardized products which may or may not meet the customer's needs. However, customization of complex products increases design costs since each product must be individually configured per customer specifications. Typically, customized designs require analysis of customer elections and general engineering constraints to generate a final configuration that fulfills the requirements of the customer while remaining within the environmental and engineering limitations of the product.

Generally, design engineers manually build the engineering parts, create point solutions or part specific Knowledge Base Engineering (“KBE”) applications and use an existing product structure approach. However, even with the use of KBE applications, much of the design process requires manual design of the product by the designers. Alternatively, designers create “point solutions,” where a particular problem is solved without regard to related issues.

Significant problems with current design methodologies include time necessary to complete the complex design as well as lack of standardization in the resulting designs. For customized products, this design expense recurs for each product produced, increasing product expense, and delaying production of the product and delivery to customers. In addition, as a result of the individual choices made by separate designers or design groups, resulting designed products are likely to be inconsistent. Such differences can increase build or construction time and reduce reusability of parts. Lack of standardization as well as the time necessary to create complex designs result in high costs associated with custom, complex designs.

### SUMMARY

The following summary is intended to provide a simple overview as well as to provide a basic understanding of the subject matter described herein. It is not intended to describe or limit the scope of the claimed subject matter. Furthermore, this summary is not intended to describe critical or key elements of the claimed subject matter. Additional aspects and embodiments are described below in the detailed description.

Systems and methods for customized design of complex products, such as airplanes or ships, are described herein. In an embodiment, a method includes obtaining a custom specification that describes at least one option for the product; obtaining predefined configuration data that comprises: a commodity feature definition that describes a plurality of commodities associated with the product, a commodity interface definition that describes interface requirements among said plurality of commodities, a design table that associates said commodity feature definition and said commodity interface definition for a commodity, and a hierarchy of said plurality of commodities; and generating the design configuration as a function of said custom specification and said predefined configuration data, wherein said hierarchy of said plurality of commodities controls order in which said plurality of commodities are applied to said product for automatic generation of the design configuration and said commodity interface definition with said design table ensure coordination among said plurality of commodities.

In another embodiment, a method includes obtaining a custom specification that describes at least one option for the aerospace product; obtaining predefined configuration data that comprises a commodity feature definition that describes a plurality of commodities associated with the aerospace product, a commodity interface definition that describes interface requirements among said plurality of commodities, a design table that associates said commodity feature definition and said commodity interface definition for a commodity, and a hierarchy of said plurality of commodities; and generating the design configuration as a function of said custom specification and said predefined configuration data, wherein said hierarchy of said plurality of commodities controls order in which said plurality of commodities are applied to said product for automatic generation of the design configuration and said commodity interface definition with said design table ensure coordination among said plurality of commodities.

In yet another embodiment, a system includes a product hierarchy that specifies a hierarchy of a plurality of commodities for the configuration of the product, an interface logic tree that specifics interface requirements for said plurality of commodities, a plurality of commodity logic trees, wherein each of said plurality of commodity trees specifies one of said plurality of commodities, and a configuration component that generates the configuration as a function of a customer selection, said product hierarchy, said interface logic tree, and said plurality of commodity logic trees.

The features, functions and advantages that have been discussed can be achieved independently in various embodiments or may be combined in yet other embodiments further details of which can be seen with reference to the following description and drawings.

### BRIEF DESCRIPTION OF THE DRAWINGS

The claimed subject matter is described with reference to the accompanying drawings. A brief description of each figure is provided below. Elements with the same reference number in each figure indicated identical or functionally similar elements. Additionally, the left-most digit(s) of a reference number indicate the drawing in which the reference number first appears.

FIG. 1 is a block diagram of a configuration system that automatically generates a custom design configuration for a complex product in accordance with an aspect of the subject matter described herein;

FIG. 2 is a flowchart of a configuration process in accordance with an aspect of the subject matter described herein,

FIG. 3 is a block diagram of a system that provides for predefined configuration data in accordance with an aspect of the subject matter described herein;

FIG. 4 illustrates an exemplary matrix of commodity feature data in accordance with an aspect of the subject matter described herein;

FIG. 5 is a block diagram of a logic structure for a commodity feature definition in accordance with an aspect of the subject matter described herein;

FIG. 6 illustrates an exemplary matrix of commodity interface data in accordance with an aspect of the subject matter described herein;

FIG. 7 is a block diagram of a logic structure for a commodity interface definition in accordance with an aspect of the subject matter described herein;

FIG. 8 is a block diagram of a logic structure for a product hierarchy definition in accordance with an aspect of the subject matter described herein;

FIG. 9 is a diagram of a product template definition in accordance with an aspect of the subject matter described herein;

FIG. 10 is another aspect of a configuration system in accordance with an aspect of the subject matter described herein;

FIG. 11 depicts an exemplary bill of materials in accordance with an aspect of the subject matter described herein;

FIG. 12 is a flowchart of a pre-design process in accordance with an aspect of the subject matter described herein;

FIG. 13 is a flowchart of a configuration process in accordance with an aspect of the subject matter described herein;

FIG. 14 is a flowchart of another embodiment of the configuration process in accordance with an aspect of the subject matter described herein;

FIG. 15 is a flowchart of a process for creating a product template definition in accordance with an aspect of the subject matter described herein; and

FIG. 16 is a flowchart of a process for creating a customer specific end item in accordance with an aspect of the subject matter described herein.

### DETAILED DESCRIPTION

The design and configuration of complex products requires thousand or even millions of individual decisions including number, type, and placement of product modules. Customers prefer customization, even in complex products such as airplanes. The result of this customization is an increase in expense, due to the time and labor costs for design engineers to create a configuration of the product that meets the customer specific requirements, as well as the engineering constraints of the product. For example, the interior of the aircraft, including the galley, seating, storage, can be designed in literally billions of combinations. As a result, it can take a team of design engineers months to develop a particular design configuration that meets both the customer specifications (e.g., closest, galley features and the like) and engineering requirements (e.g., electrical connections, space restrictions and the like).

Systems and methods for customized design of complex products, such as airplanes or ships, are described herein. In an embodiment, a set of predefined configuration data that defines product requirements and options is specified prior to generation of customized design configurations. In an aspect, the predefined configuration data includes specification for a set of commodities that make up the product and may also include information regarding the interfaces between various commodities. In addition, the predefined configuration data can include hierarchy information that controls the order of the design process to facilitate custom design generation.

In another aspect, custom specifications are obtained, via a user interface, a file of defined options, or any other suitable means. The custom specifications may be processed in conjunction with the predefined configuration data, based at least in part upon the predefined hierarchy information. As a result, this embodiment provides an automated configuration process able to generate multiple, custom design configurations based upon individual custom specifications and utilizing a consistent set of predefined configuration data.

An advantage of aspects of the described system and methods is speed in generation of individualized design configurations. In a further aspect, once the predefined configuration data is specified, one or more customized design configurations can be created in a relatively short period of time. Furthermore, the use of the automated systems and/or methods described herein may facilitate consistency across the generated designs. Use of consistent predefined configuration data may facilitate standardization of parts, decreasing costs. The systems and methods are described in further detail below with respect to the figures.

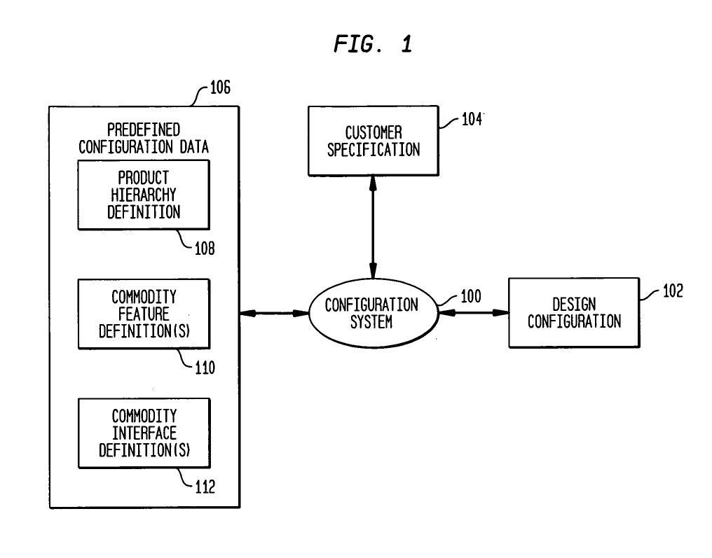

Referring to FIG. 1, an embodiment of a configuration system 100 that automates generation of a custom design configuration 102 for a product based upon predefined product constraints as well as customer selected options or features, is illustrated. As used herein, terms such as “component” and “system” refer to computer-related entities, such as hardware, firmware, software or any combination thereof, including software in execution. For example, a component may be, but is not limited to, a process running on a processor, a processor, an object, an exceutable, a thread of execution, a program, and/or a computer. Both an application running on computer and the computer can be a component.

In an aspect, the configuration system 100 obtains a customer specification 104 that defines or describes customer selected options for the design configuration 102 of the customized product. As used herein, the term “customer” refers to any individual or entity that elects options that are to be incorporated in the design configuration 102. In an aspect, a customer utilizes a user interface or other tool to produce file, database, or other collection of data, which defines the customer specification 104. In another example, the configuration system 100 incorporates a user interface, such as a graphical user interface (“GUI”) that allows customers to select from available options to generate the customer specification 104. In an aspect, based upon the customer specification 104, the configuration system 100 determines customer requirements, which are utilized in conjunction with predefined product constraints, to generate the custom design configuration 102. This custom design configuration 102 can be used to produce a customized product for the customer.

In an aspect, the configuration system 100 utilizes predefined product or configuration data 106 that defines product constraints and requirements. This predefined configuration data 106 is used in combination with the customer specification 104 to create a custom design configuration 102. In an aspect, the predefined configuration data 106 details parts of the product as well as rules and/or logic for creation of design configuration 102 for the product. Complex products are typically composed of numerous substructures or parts, referred to herein as commodities. For example, an airplane interior is composed of many commodities, including seats, signs, video monitors, closets, and the like. Each commodity may have one or more elements or characteristics, referred to herein as features. For example, the features of an airplane closet commodity include height, width, literature pockets, monitors and the like. It will be understood this terminology is used for convenience and that multiple levels of structures and substructures may be utilized. In an aspect, the predefined configuration data 106 describes commodities, commodity features, and methods for and/or constraints on combining commodities within the design configuration 102. The predefined configuration data 106 is depicted in FIG. 1 as separate and distinct from the configuration system 100; however, it will be understood that the predefined configuration data 106 or any subcomponents thereof, may be incorporated within the configuration system 100.

In an aspect, the predefined configuration data 106 includes a product hierarchy definition 108 that specifies an order in which commodities of the product are processed during generation of the design configuration 102. In an aspect, the product hierarchy definition 108 is implemented as a sequence or logic tree. For example, an airplane level sequence logic tree (“ALSLT”) is a product hierarchy definition 108 that defines the order in which the airplane interior commodities are to be defined and integrated into the design configuration 102. In an aspect, the product hierarchy definition 108 is strategically designed to facilitate the generation of a design configuration 102, ensuring that critical commodities or commodities with limited options are implemented prior to more flexible commodities. Returning to the airplane interior example, seats, galleys, and lavatories would all be prioritized before optional and/or easily placed items, such as video monitors and signs. Therefore, seats, galleys and lavatories and their features would be prioritized in the product hierarchy definition 108.

In another aspect, the predefined configuration data 106 also includes one or more commodity feature definitions 110 and/or commodity interface definitions 112. The commodity feature definition I 10 defines a commodity and one or more features associated with that commodity. The commodity feature definition 110 includes all possible features of the given commodity as well as rules for feature selection and configuration of the commodity within the product. In an aspect, the commodity feature definition 110 is implemented as a commodity logic tree (“CLT”), described in further detail below.

The commodity interface definition 112 specifies the interface requirements of external interfacing commodities. In an aspect, the commodity interface definition 112 captures rules and feature selection requirements necessary to create a valid commodity configuration based upon the external interface requirements. For example, commodities may have location restrictions or electrical interface requirements. In an aspect the commodity interface definition 112 is integrated as a logic tree, the interface logic tree (“ILT”), described in further detail below.

To generate the custom design configuration 102, the configuration system 100 parses the customer specification 104 and processes the customer commodity and feature selections based upon the predefined configuration data 106. In an aspect, the configuration system 100 utilizes the product hierarchy definition 108 to determine the order in which commodities are specified. In another aspect, the product hierarchy definition 108 controls the configuration process, ensuring that each commodity is fully specified in turn. In an aspect, as each commodity is processed, the relevant commodity feature definition 110 and commodity interface definition 112 are obtained or retrieved. In a further aspect, the commodity feature definition 110 and commodity interface definition 112 contain rules and logic for specifying the individual commodity in conjunction with the customer specific options. Upon completion, a design configuration 102 is produced that meets the constraints of the individual commodities and the overall product, while incorporating customer specific features and options.

In an aspect, the design configuration 102 produced by the configuration system 100 can be used with standard product management software, such as ENOVIA VPLM V5, marketed by IBM®. As a result, the configuration system 100 can be integrated with existing product management systems and processes, resulting in nearly seamless design and production. For example, the design configuration 102 can include sufficient part information to allow for use of the design configuration 102 in ordering and production of parts as well as the manufacturing of the customized product.

Advantages of the configuration system 100 include the reduction of development time for creation of a customized product and the standardization of design. Use of predefined configuration data 106 for multiple custom design configurations 102 reduces or eliminates recurring design costs. Automatic generation of custom design configurations 102 can reduce the design time from months to minutes or even seconds. While a significant investment of time is likely to be required for initial development of predefined configuration data 106, the reduction in recurring costs is likely to be far greater than any additional expense at project initiation.

The configuration system 100 also provides for standardization of design, while allowing for development of customized design configurations 102. In an aspect, the configuration system 100 utilizes a standard set of predefined configuration data 106 including commodity and feature definitions, as well as rules or logic for the creation of design configuration 102. Consequently, the resulting design configurations 102, while customized, are consistent, avoiding inconsistencies due to individual processes of design engineers or engineering teams. As an added benefit, this consistency may reduce production costs, since standardization of parts typically results in a reduction in part costs.

To ensure quality, the custom design configurations 102 may be reviewed upon completion. Identification of non-conformances or inconsistencies among the design configurations 102 may trigger update or correction of the underlying predefined configuration data 106. A single correction in the predefined configuration data 106 ensures that any future design configurations 102 produced using such data will incorporate the correction.

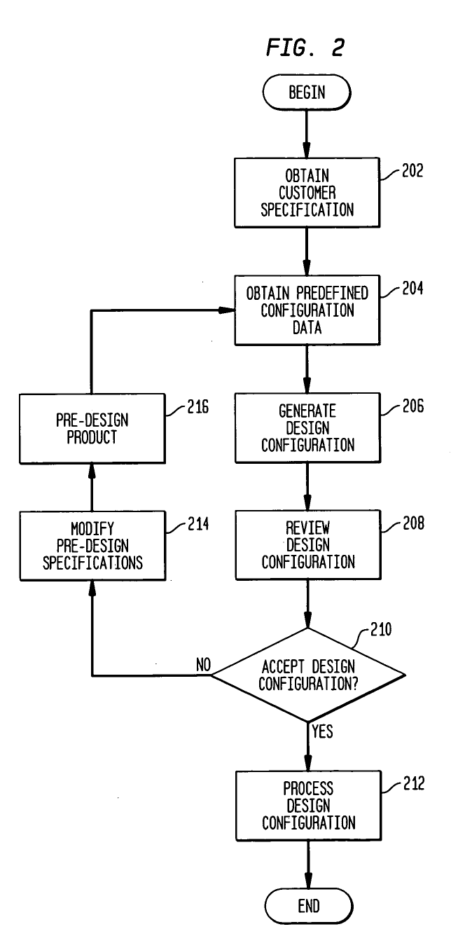

With reference to FIGS. 2, and 12-16, flowcharts depicting methodologies associated with generation of custom design configurations are illustrated. For simplicity, the flowcharts are depicted as a series of steps or acts. However, the methodologies are not limited by the number or order of steps depicted in the flowchart and described herein. For example, not all steps may be necessary; the steps may be reordered, or performed concurrently.

FIG. 2 is a flowchart depicting an exemplary configuration process. The word “exemplary” is used herein to mean serving as an example, instance, or illustration. The subject matter disclosed herein is not limited by such examples. In addition, any aspect or design described herein as “exemplary” is not necessarily to be construed as preferred or advantageous over other aspects or designs.

The configuration process depicted in FIG. 2 occurs after pre-design of the product is complete. Product pre-design is described in detail below and comprises the generation predefined configuration data 106. In an aspect, that predefined configuration data 106 incorporates the available commodities, option attributes, and engineering features for a product. Although the pre-design may require significant processing, pre-design occurs relatively few times during the product lifetime, possibly only a single time.

During the configuration process depicted in FIG. 2, at step 202, a customer specification 104, including specific selections of options, is obtained. In an aspect, a customer specification 104 is obtained by retrieving or receiving a file or collection of data that defines the custom selections. At 204, predefined configuration data 106 for the relevant commodities and features is obtained. At 206, a custom design configuration 102 is created based at least in part upon predefined configuration data 106 created during pre-design and upon the customer specification 104. The resulting design configuration 102 is customized for a particular customer, while incorporating the constraints and requirements of the predefined configuration data 106.

At step 208, the design configuration 102 is reviewed and/or tested to ensure compliance with the customer selections and product requirements. This review may be automated, conducted manually by design engineers or a combination thereof. If it is determined at step 210 that the design configuration 102 is acceptable and meets the configuration requirements, the design configuration 102 is released at 212 and the configuration process is complete. The released design may be utilized in production or manufacture of the customized product.

Alternatively, if it is determined at step 210 that the design configuration 102 is unacceptable or nonconforming, the configuration process continues at step 214, where the predefined configuration data 106 is modified to correct for the design configuration nonconformity. Upon adjustment, the pre-design process is performed at step 216, such that the modification is incorporated into all of the predefined configuration data 106 and will be used for the configuration process. The process then continues at step 206, where the design configuration 102 is generated using the updated predefined configuration data 106 and the customer specification 104.

The result of utilizing a standardized set of predefined configuration data 106 to create multiple design configurations 102 is an overall decrease in processing time for creation of multiple, customized design configurations 102, as well as an assurance of consistency across multiple design configurations 102. This consistency may reduce costs in production and ensure quality of the completed design configurations 102. The reduction in processing time decreases design costs and results in faster overall production of a customized, complex product.

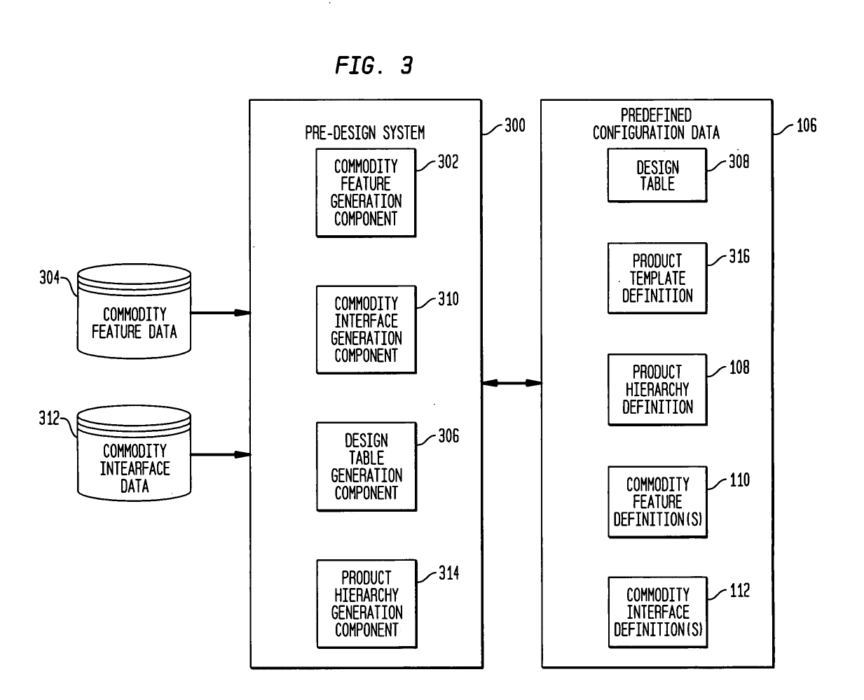

Referring to FIG. 3, an exemplary pre-design system 300 performs pre-processing or pre-specification of the product, commodities and features to facilitate the rapid generation of customized design configurations 102. Although illustrated as a single pre-design system 300 with multiple components, pre-design can be performed utilizing multiple independent components, processes or software applications. In another aspect, the pre-design system 300 is incorporated into the configuration system 100.

In an aspect, the pre-design system 300 includes a commodity feature generation component 302 that produces one or more commodity feature definitions 110 for use by a configuration system 100 in generating design configurations 102. In aspects, the commodity feature generation component 302 utilizes commodity feature data 304, which may be provided by design engineers, to generate a standardized commodity feature definition 110 for use by the configuration system 100. In an aspect, commodity feature data 304 is structured as a table or matrix, also referred to herein as a variability matrix (“VM”).

In an aspect, a commodity is a physical product consisting of part definition performing a specific set of interrelated product functions. There may be multiple types or categories of commodities, for example for an airplane product there may be two types of commodities: interior commodities and enabling commodities. In this example, an interior commodity is typically an equipment item or furnishing that is variable in location, type, and appearance, including linings, stowage, seats, and monuments (e.g. closets). An enabling commodity is a part of the baseline architecture elements of the airplane, including systems such as water, waste, oxygen, electrical, cabin systems and environmental control systems.

Commodities may be grouped in commodity families for management. In an aspect, a commodity family consists of a set of commodities with similar functions, with differences such as location in the airplane. For example, the closet commodity family consists of individually defined, customer selectable centerline and sidewall closet commodities. An advantage of using commodity families is to group commodities with similar functions under a single engineering design team for the purposes of design consistency, commonality and reusability.

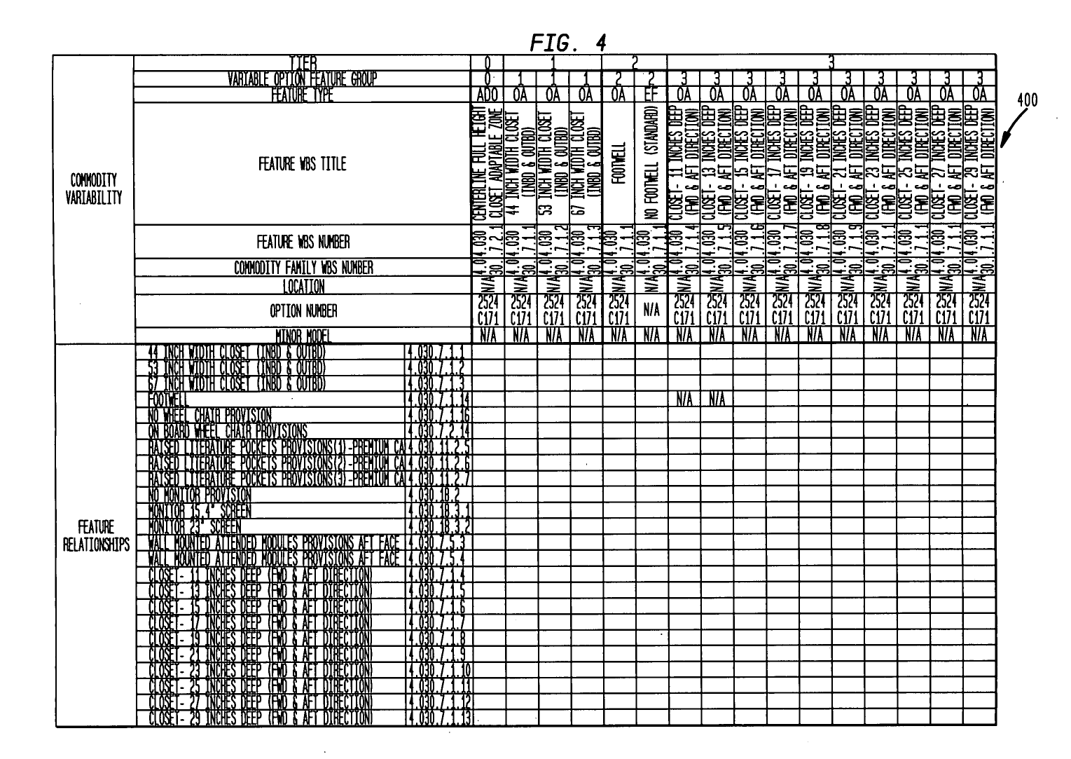

FIG. 4 illustrates exemplary commodity feature data 304 for an airplane interior commodity, in particular a closet commodity. Here, the commodity feature data 304 is represented as a variability matrix 400 containing available features for a closet commodity. The commodity features include option attribute (“OA”) type features, which can be selected by customers to create a customized interior, as well as engineering feature (“EF”) type features, which are not selectable by the customer and are necessary to complete the commodity definition. The features may also include attribute driven options (“ADOs”), which are options that require the selection of additional features to complete the option definition. For example, as shown in the commodity feature data matrix 400, selection of a Centerline Full Height Closet Adaptable Zone option, then requires selection of one of a 44, 53 or 67 inch width closet.

The illustrated matrix 400 of commodity feature data identifies valid and invalid combinations of features and options. For example, the matrix 400 indicates that foot wells are not permitted for closets having depths of either 11 inches or 13 inches. In this manner, the commodity feature data describes not only the individual features, but also interactions between selections of certain features. As shown in FIG. 4, the commodity feature data can include identifiers for various features or options. In an aspect, particular work breakdown structure (“WBS”) identifiers that identify parts, features and/or options are provided in the matrix 400. These identifiers can be incorporated into the predefined configuration data 106 and ultimately into the design configurations 102 created using the predefined configuration data 106. In an aspect, the incorporation of part identifiers in the design configuration 102 facilitates the transition from design to automation of production and manufacture.

The illustrated matrix 400 contains commodity feature data for a single commodity, an airplane closet. In an aspect, a separate matrix, file or logic structure is defined for each commodity available for a product. In another aspect, commodity feature data is maintained in a spreadsheet, such as an Excel® spreadsheet. Accordingly, a separate spreadsheet or file can be used for each individual commodity.

Referring again to FIG. 3, in an aspect, the commodity feature generation component 302 obtains commodity data from a commodity feature data store 304, such as the variability matrix illustrated 400 in FIG. 4. In a further aspect, based upon the obtained data, the commodity feature generation component 302 creates a logic structure, such as a tree, graph or other logic structure, that models or expresses the applicable features for the commodity as well as the design rules for the particular commodity. The commodity feature generation component 302 can process each commodity associated with the product to produce the necessary commodity feature definitions 110.

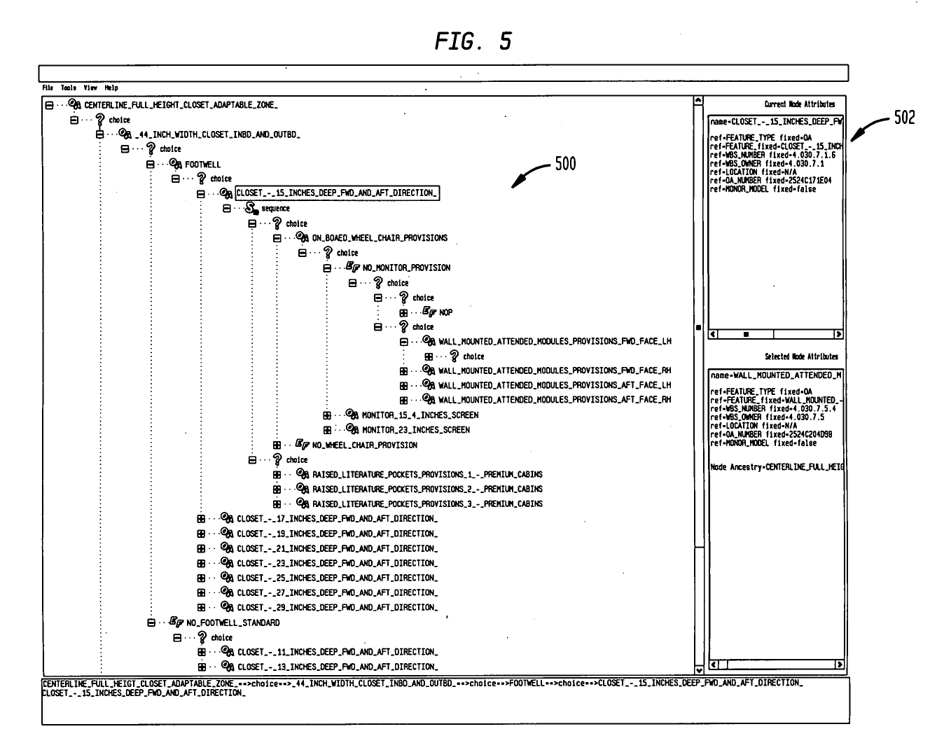

Referring to FIG. 5, in an aspect, the commodity feature generation component 302 utilizes the commodity feature data 304 to generate a logic structure, such as a tree, that describes the relationship of commodity features and options. In an aspect, a commodity logic tree facilitates the validation of accuracy and completeness of commodity feature data 304, or a variability matrix. An exemplary commodity logic tree is illustrated in FIG. 5, depicting the structure of features and various options for an airplane closet commodity. The illustrated closet definition includes both option attributes (OAs) and engineering features (EFs). As depicted, the various airplane features are contained within a hierarchy that depicts the available choices between predefined alternatives (e.g., the closet must be one of 15, 17, 19, 21, 23, 25, 27 or 29 inches in depth). The selection of a particular feature or option, logically leads to a subset of options. For example, as illustrated, selection of a 15 inch deep closet leads to additional selections, such as onboard wheelchair provisions, and monitors of 15 or 23 inches. Consequently, traversal of the illustrated logic tree defines a particular airplane commodity and its associated features. In an aspect, attributes 502 associated with the features are maintained with the logic tree and selection of the features will retrieve the associated attribute data.

Turning once again to FIG. 3, in an aspect, the pre-design system 300 includes a design table generation component 306 that produces one or more design tables 308 based at least in part upon the commodity feature data 304. In an aspect, the produced design table 308 is specific to a particular commodity. In a further aspect, the design table 306 associates the commodity feature data logic, the commodity feature data 304 and interface data 312 for a commodity. In a further aspect, the design table 308 is implemented as a spreadsheet, such as an Excel® spreadsheet. Table 1 below illustrates an exemplary design table 308 for a closet commodity of an airplane interior. In an aspect, during the configuration process, customer options are added to the design table 308 to create a customized design table (described below) as part of the design configuration 102.

TABLE 1
Exemplary Design Table

| | | | CENTERLINE | 44 INCH | 53 INCH | | |
|---|---|---|---|---|---|---|---|
| | | | FULL HEIGHT | WIDTH | WIDTH | | |
| | | | CLOSET | CLOSET | CLOSET | | NO |
| | | Line | ADAPTABLE | INBD AND | INBD AND | | FOOTWELL |
| | Customer | Number | ZONE | OUTBD | OUTBD | FOOTWELL | STANDARD |
| WBS | N/A | N/A | 4.030.7.2.1 | 4.030.7.1.1 | 4.030.7.1.2 | 4.030.7.1.14 | 4.030.7.1._{—} |
| | BEJ | 8 | | | x | | x |

| | CLOSET - | CLOSET - | CLOSET - | CLOSET - | CLOSET - | CLOSET - |
|---|---|---|---|---|---|---|
| | 11 INCHES | 13 INCHES | 15 INCHES | 17 INCHES | 19 INCHES | 21 INCHES |
| | DEEP FWD | DEEP FWD | DEEP FWD | DEEP FWD | DEEP FWD | DEEP FWD |
| | AND AFT | AND AFT | AND AFT | AND AFT | AND AFT | AND AFT |
| | DIRECTION | DIRECTION | DIRECTION | DIRECTION | DIRECTION | DIRECTION |
| WBS | 4.030.7.1.4 | 4.030.7.1.5 | 4.030.7.1.6 | 4.030.7.1.7 | 4.030.7.1.8 | 4.030.7.1.9 |
| | | | x | | | |

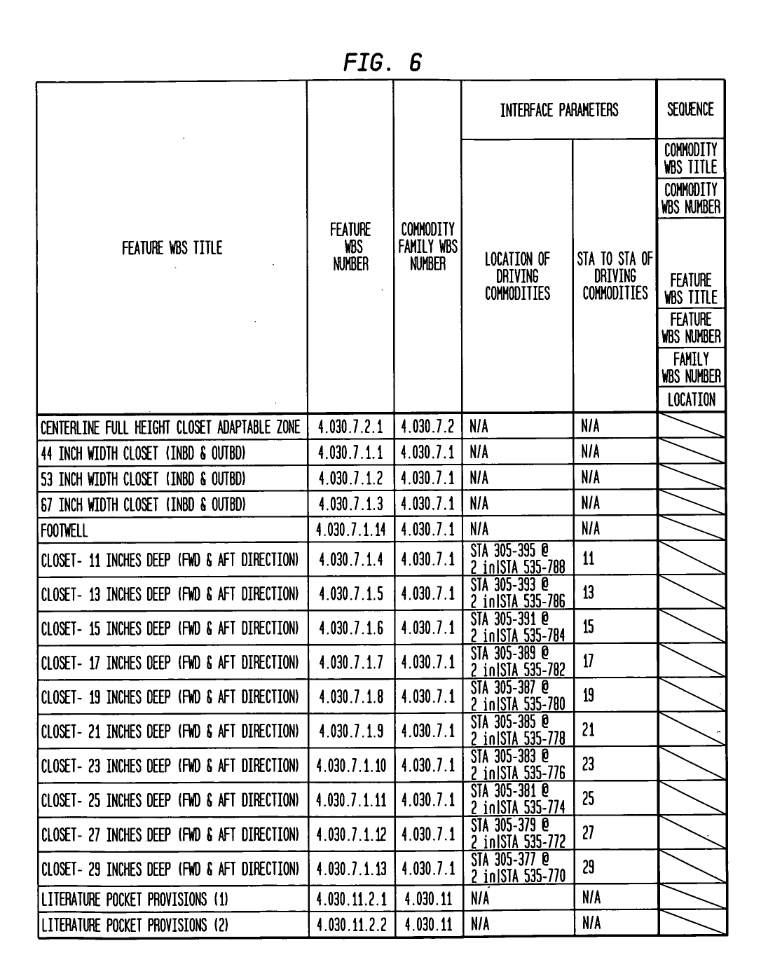

Referring now to FIG. 6, in another aspect, the pre-design system 300 includes a commodity interface generation component 310 that generates a commodity interface definition 112 based at least in part upon obtained commodity interface data 312. In an aspect, the commodity interface data 312 may also be derived, at least in part, from the commodity feature data 304. In an aspect, commodity interface data 312 is implemented as a set of matrices or tables, such as the interface matrix illustrated in FIG. 6, that define commodity-to-commodity interactions. The commodity interface data 312 defines valid relationships between inter-dependent commodity features. In an aspect, a commodity interface data 312 includes a set of interface matrices, where a separate matrix is specified for each commodity and each matrix represents the relationship between the given commodity and other commodities for which the possibility of an interface exists. The illustrated matrix can show valid relationships between interdependent options.

In a further aspect, the commodity interface data 312 is expressed utilizing one or more spreadsheets, such as Excel® spreadsheets. In another aspect, the particular WBS identifiers for various commodities, features and options are contained within the commodity interface data 312 and incorporated into the predefined configuration data 106 and eventually design configurations 102.

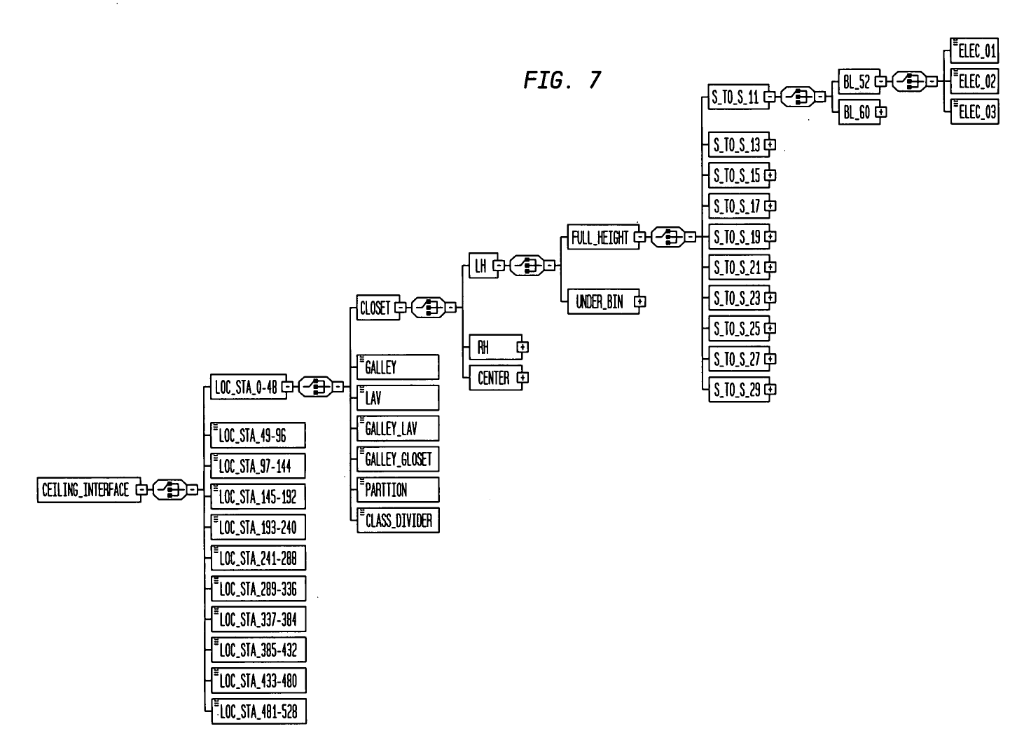

FIG. 7 illustrates an exemplary commodity interface definition 112 generated by the commodity interface generation component 310 as a function of the provided commodity interface data 312 as well as commodity feature data 304 for a particular commodity. In a further aspect, the commodity interface definition 112 can be used to validate the completeness and accuracy of the commodity interface data 312. In an aspect, a commodity specific logic tree captures the rules and feature selection for a valid commodity configuration, driven by interface requirements of external interfacing commodities. In an aspect, the commodity interface definition 112, shown as an interface logic tree, is a commodity specific representation of features intended to show parent-child relationships between those features, thereby capturing the rules for feature selection sequencing for a valid commodity configuration, driven by interface requirements of external interfacing commodities. In an aspect, the interface logic tree is derived based upon the structure of the commodity interface data 312.

In particular, the illustrated commodity feature definition 110 relates to design of an airplane interior. As depicted, the various airplane interfaces for a particular commodity are contained within a hierarchy that depicts possible interfaces between predefined alternatives. The selection of a particular commodity interface, logically leads to a subset of options. Consequently, traversal of the illustrated logic tree defines the interfaces for a commodity. In an aspect, at each level of the interface logic tree, there is a choice or a set of options of the same type. During traversal, a single option is elected at each juncture, and traversal continues by moving on to the next juncture or choice until the end of a branch of the tree is reached. The result is a conclusion or unique list of features and parameters describing the interface requirement for a unique instance of a commodity.

Turning again to FIG. 3, in an aspect, the pre-design system 300 includes a product hierarchy generation component 314 that produces the product hierarchy definition 108. In another aspect, the product hierarchy definition 108 is manually generated by one or more designers. The product hierarchy definition 108 is based at least in part upon commodity interface data 312 and is designed to control the order of design to facilitate processing. In an aspect, the aggregate of all commodity interface definitions 112 (ILTs) and commodity feature definitions 110 (CLTs) facilitates the development of a valid and stable product hierarchy definition 108. In a further aspect, the product hierarchy definition 108 is utilized during customer design and generation of the customer specification 104 to correctly sequence the configuration of the commodities, resulting in an integrated customer specification 104. In a further aspect, the product hierarchy definition ensures the sequence of the design configuration 102, including development of a customized bill of materials and customer specific end item (discussed below), results in an integrated set of commodities for a customer.

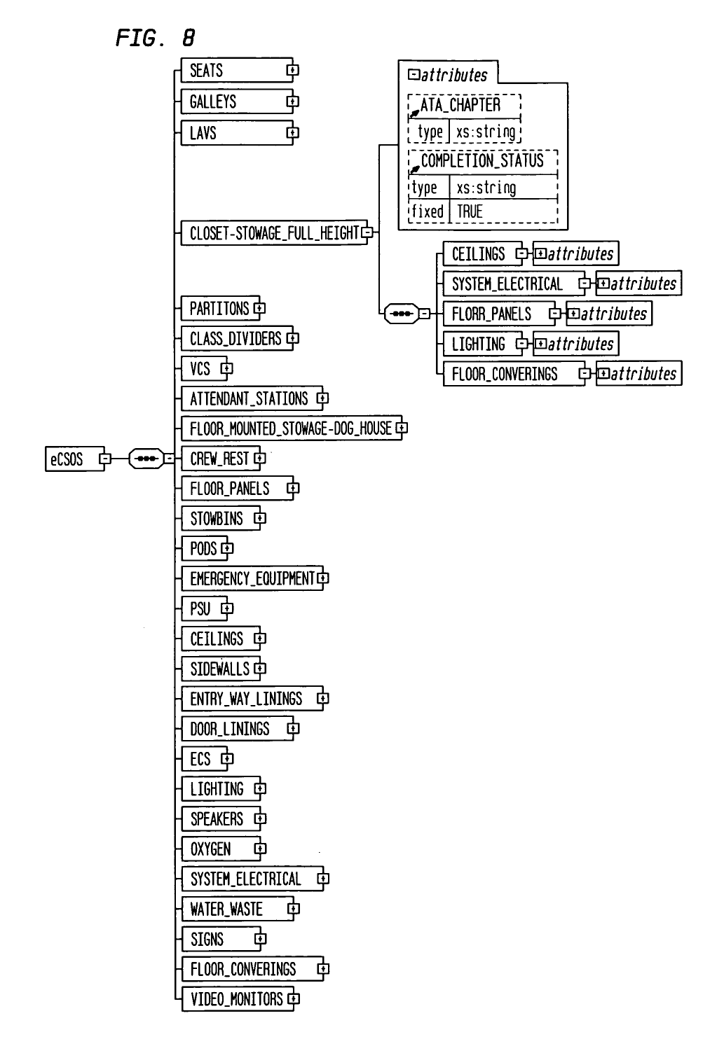

Referring now to FIG. 8, an exemplary product hierarchy definition 108 is illustrated. In particular, FIG. 8 illustrates an airplane level sequence logic tree (ALSLT) that defines the order in which the airplane interior commodities are to be defined and integrated. For example, as shown, seat, galley and lavatory commodities would be fully processed prior to closet commodities. Traversal of the depicted tree results in ordered and complete processing of the product commodities. Although a tree logic structure is illustrated, any suitable structure (e.g., a rule set, graph) can be utilized to define the order in which individual commodities are to be processed. In an aspect, the product hierarchy definition 108 is specified using extended markup language (XML) and can be created using a tool for creating XML documents, such as XMLspy available from Altova®. The processing order is based upon the requirements of the product.

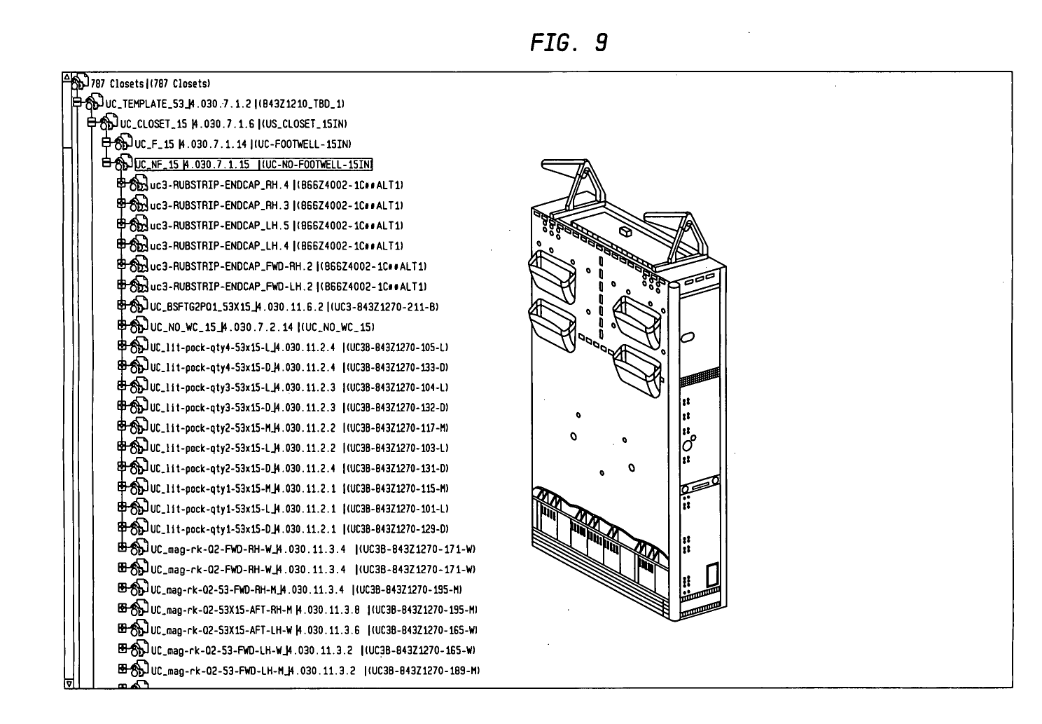

Turning now to FIG. 9, a product template definition (“PTD”) 316 is illustrated. In another aspect, during pre-design, a product template definition 316 is created for each commodity, where a product template definition 316 represents all possible permutations of a commodity and is based at least in part upon the commodity feature data 304. In an aspect, the product template definition 316 is created using approved commodity feature definitions 110. In a further aspect, the product template definition 316 organizes the product definition data for a commodity in a way that supports efficient and timely automation. In another aspect, WBS identifiers are included within the product template definition 316 based upon commodity feature data 304 and can be used to create the product definition data (i.e. part definition) content in the customized bill of materials (described below). In a further aspect, the product template definition 316 consists of instances of other fixed or variable assemblies and instances of fixed or variable detailed parts. In an aspect, the product template definition 316 provides feature definition data during configuration process to create the customer specific design configuration 102, discussed in detail below.

In an aspect, product template definitions 316 or PTDs are created by one or more design engineers and are formatted for use by the configuration system 100 in generation of a design configuration 102. In particular, product template definitions 316 can be used in creation of the customer specific end item 1014. In another aspect, product template definitions 316 are implemented as Enterprise InNOvation VIA (ENOVIA)/V5 model component assemblies (CA) containing, as children, formatted parts (e.g., CATParts) of pre-designed parts/assemblies. There may be multiple PTDs 316 for a commodity family. For example, in the airplane product example, the closet family may have a PTD 316 for centerline closets and a separate PTD 316 for outboard closets. In an aspect, the number and types of PTDs 316 will depend upon the commodities and commodity families that make up the product that is the subject of the design configuration 102.

In a further aspect, PTDs 316 are composed of complex component assemblies (CAs). As used herein, a component assembly or CA can be an assembly part structure method as used in ENOVIA LCA and CATIA. Typically, CAs consist of a part reference that contains child parts. In an aspect, the PTD itself is a complex CA. It also contains simple CAs, complex parts and formatted parts (e.g., CATParts). The complex CA, including the PTD 316 itself, contains all selectable commodity features represented as multiple part instances. The commodity PTD product structure is developed with the aid of the commodity feature definition 110, such as a commodity logic tree. Simple CAs are contained within the PTD 316. Simple CAs contain fixed numbers of components and represent collections of parts assigned to a particular feature. Simple CAs can be reused within a single PTD 316 or across multiple PTDs 316.

In further aspects, a PTD 316 can contain two types of simple component assemblies. The first type of simple component assembly is an actual assembly of parts within a feature that when selected, is carried over to the customer specific end item 1014 and is released. The other type of simple component assembly can be a decision node (DNO), which is a modeling technique that acts as a vehicle to capture a collection of parts representing a selected feature for the purpose of populating the customer specific end item 1014. The DNO can serve as a vehicle for collecting parts necessary to complete the engineering definition when a feature is selected. Once the DNO serves its purpose to populate the customer specific end item 1014 with parts, the DNO “collector” is no longer required and is not included in the customer specific end item 1014. In this aspect, a DNO is a means by which a group of parts is associated to a single feature from a commodity feature definition or variability matrix.

In an aspect, a PTD 316 also includes a component assembly requirements model (CARM), which is an engineering requirements model that contains engineering requirements for assembling the child parts into the component assembly. For example, in CATIA, the component assembly is a collection of the part objects. In an aspect, the component assembly includes a CARM that contains some reference geometry, tolerancing, and annotations to define how the child parts are assembled together. For the purposes of the PTD 316, the CARM provides requirements to assemble models within an assembly.

In an aspect, an advantage of PTDs 316 is reduction customization cost and cycle time by organization of design and variability during option pre-design for a product. In an aspect, initial PTDs 316 for a product may not contain all permutations of the variable design. The configuration process can reuse some previously designed features, driven by specific customer configurations. Over the span of multiple customer specifications 104, combinations of customer design configurations 102 are designed, released, and used to update and improve the PTDs 316. The PTDs 316 mature including increasing numbers of permutations of the design. Eventually all permutations of the design may be represented in the completed PTDs 316.

In an aspect, the PTD is associated with other product information for use in generating the design configuration 102. For example, in an aspect, commodity feature data 304 represents compatibility of features that are represented as parts and assemblies in the PTD 316. The commodity feature definition 110, which may be implemented as a commodity logic tree, is a hierarchal view of the commodity feature data 304, showing tiers of choices available for feature selection and can be used to validate the completeness of the PTD 316. In another aspect, the design table 308 is populated with selectable features, represented as parts and assemblies in the PTD 316, that once selected via a customer specification 104 are “pulled” from the PTD 316 to create customer specific end items 1014. In a further aspect, the design table 308 maintains a historical record of selected features of customer specifications 104. In an aspect, the commodity interface data 312 shows valid relationships between features within interdependent ADO, where an ADO is an attribute driven option that requires the selection of additional features to complete the option definition. The PTDs 316 can contain features that interface with interdependent ADOs.

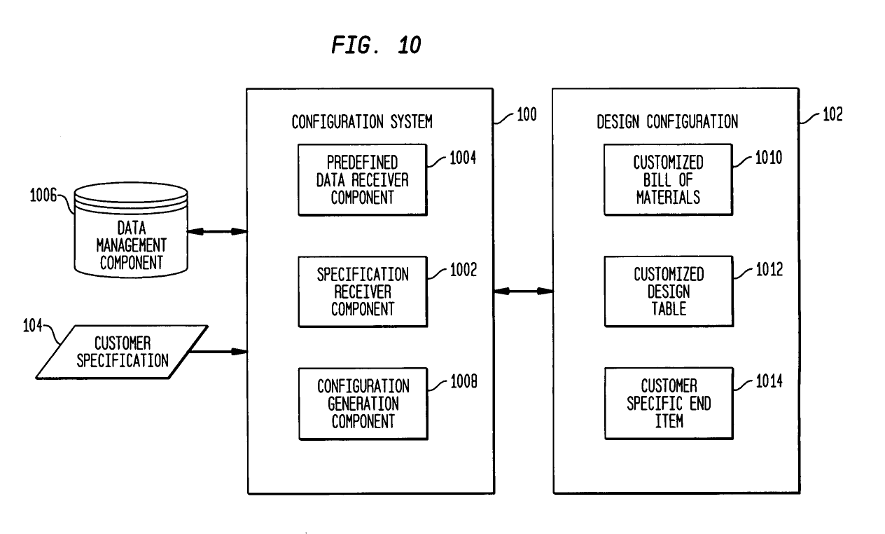

Referring to FIG. 10, another aspect of a configuration system 100 that generates customer specific design configurations 102 is illustrated. In an aspect, the configuration system 100 includes a specification receiver component 1002 that obtains customer specifications 104 for design of a particular product, such as an airplane. The customer specification 104 can be implemented using any suitable interface, including as a graphical user interface (GUI) that allows customers to select from a provided set of option attributes to customize the product. Customer specifications 104 can be provided using any suitable format. In an aspect, the specification receiver component 1002 parses the received customer specification 104 to determine selected customer option attributes.

In another aspect, the configuration system 100 includes a predefined data receiver component 1004 that obtains predefined product, commodity and feature data. Such data can be maintained in a data management component 1006. The data management component 1006 is a data store or stores that maintain the product data. As used herein, a “data store” is a collection of data, such as a file, files or database. In an aspect, the data management component 1006 using product data manager software, such as the ENOVIA project manager sold by IBM®.

In an aspect, the configuration system 100 includes a configuration generation component 1008 that synthesizes data obtained from the customer specification 104 and the predefined data obtained from the data management component 1006. As illustrated, the produced design configuration 102 can consist of multiple parts or modules. These modules can be utilized by various design, manufacture and production applications. In an aspect, it is these modules taken as a whole that fully describe the design configuration 102. In a further aspect, the design configuration 102 comprises a bill of materials 1010, a customized version of the design table 1012, and a customer specific end item 1014.

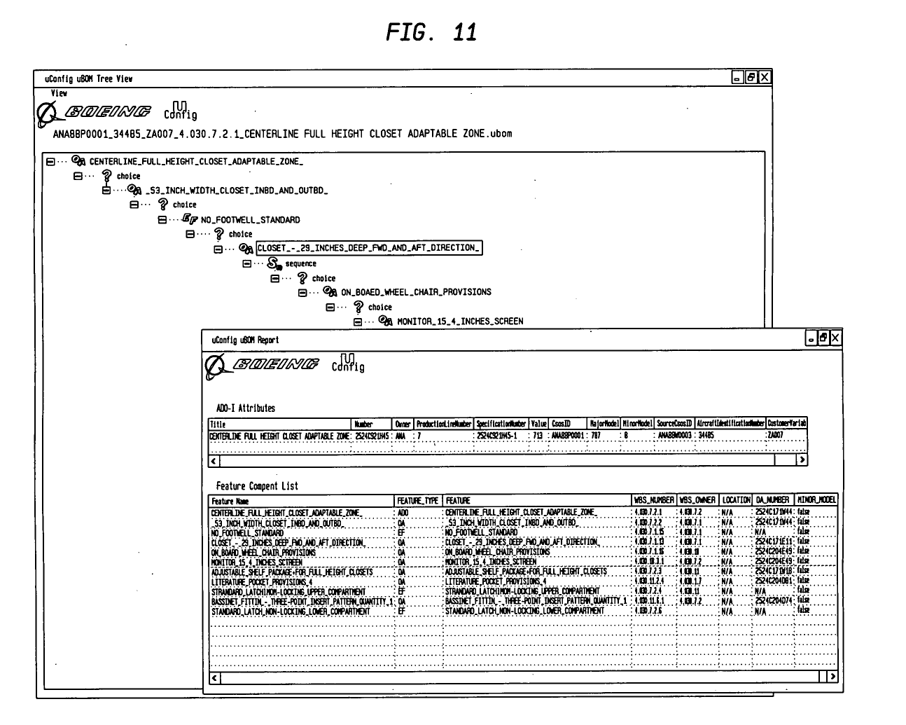

Referring to FIG. 11, an exemplary bill of materials for an airplane closet commodity is illustrated. In an aspect, the configuration system 100 produces a bill of materials 1010 that specifies the product at the feature level. As shown, individual features can be identified using predefined codes, such as the WBS identifiers used to identify all features of a commodity, including customer selectable features, and engineering features, such as feature dimensions and location. In an aspect, the bill of materials 1010 is in a standardized format that provides for further automated processing. The configuration generation component 1008 generates the bill of materials 1010 based at least in part upon the customer selections and the predefined product, commodity and feature data obtained from the data management component. In an aspect, the bill of materials 1010 describes the parts, sub-components and components necessary to manufacture the product. In a further aspect, the bill of materials 1010 contains WBS feature identifiers and rules of the feature selection process. In addition, the bill of materials 1010 provides visibility of customer feature selections as derived from the customer selected options. In addition, in aspects, the configuration generation component 1008 creates a customized design table 1012 based upon the bill of materials 1010. The customized design table 1012 is based upon the design table 308 created during pre-design; however, the customized design table 1012 is modified to specify the particular customer selections as defined in the customer specification 104. In another aspect, the customized design table 1012 is basically a transformed view of the commodity feature data 304, or variability matrix, with customer specific feature selections and additional information for part definition. In particular, the customized design table 1012 can contain the feature selection of the commodity, based on commodity logic from the commodity feature definition 110, such as traversal of a commodity logic tree. In an aspect, the customized design table 1012 includes part identifiers for the commodity parts. An advantage of a customized design table 1012 is that it associates the customer selections to the engineering design to ensure the product definition fully defines the customer specified configuration. In addition, in an aspect, the customized design table 1012 is also used to validate accuracy and completeness of the variability matrix and the commodity logic tree.

In another aspect, the configuration generation component 1008 creates a customer specific end item 1014. In a further aspect, the customer specific end item 1014 is based upon features derived from the product template definition 316 as well as the customized design table 1012 and the bill of materials 1010. This customer specific end item 1014 is also referred to as a Customer Specific End Item Instance (CS_EII). In further aspects, the customer specific end item 1014 is generated using computer aided design software, such as Computer Aided Three Dimensional Interactive Application (CATIA V5). In particular, the customer specific end item 1014 contains customer specific product definition data created and approved in ENOVIA LCA, In a further aspect, the customer specific end item 1014 represents the engineering information necessary to configure a set of customer specifications and can be used for the ordering, build and inspection of parts for the product.

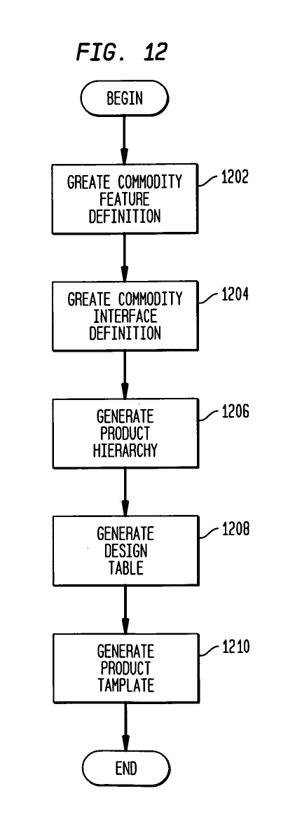

Turning now to FIG. 12, an exemplary pre-design process is illustrated. At step 1202, a set of commodity feature definitions 110 is created. A commodity feature definition 110 describes the particular features and attributes available for a given commodity. In an aspect, a separate commodity feature definition 110 is generated for each commodity associated with the product. The commodity feature definitions 110 describe not only the individual commodity features, but also the logic by which the features and attributes are selected during design of the commodity. At step 1204, a commodity interface definition 112 is created, which describes the interaction between commodities associated with the product. The interface information is be used to ensure that the selected commodities are compatible.

At step 1206, a product hierarchy definition 108 is created. The product hierarchy definition 108 determines the order or sequence in which commodities are processed during generation of a design configuration 102. At step 1208 a set of design tables 308 is created. A design table 308 associates the commodity feature data logic, the commodity feature data and interface data for a given commodity. This set of design tables 308 can be customized during the configuration process. Finally, at step 1210, a product template 316 is created, which defines the complex product, and includes the possible options and/or attributes.

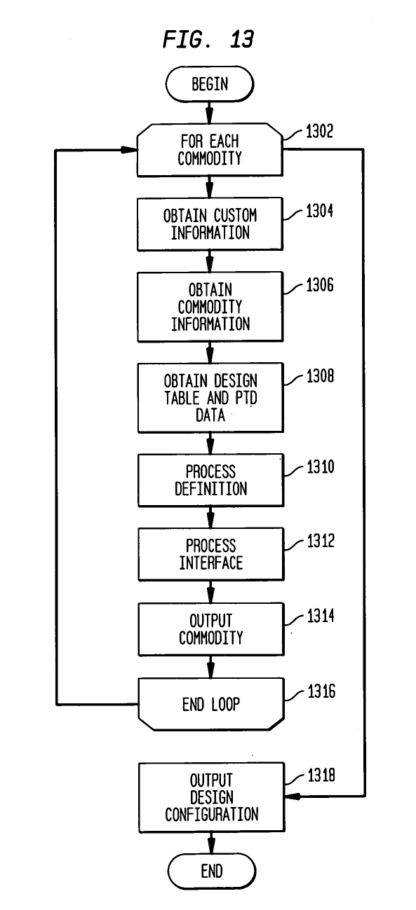

Referring to FIG. 13, an exemplary configuration process is illustrated. Each commodity of the product is processed and added to the design configuration 102 in turn. The order of processing is based at least in part upon the product hierarchy definition 108. At step 1302, a loop begins processing each commodity within the product, where the processing order is a function of the product hierarchy definition 108. The customer specification 104 data for the commodity to be processed is obtained at step 1304. At step 1306, the commodity information, including a commodity feature definition 110 as well as commodity interface definition 112 is obtained. At step 1308, relevant data from a design table 308 and a product template definition 316 are also retrieved. In an aspect, the relevant commodity feature definition 110, commodity interface definition 112, the design table 106 and product template definition 316 are retrieved from a data management system 1006.

At 1310, all of the relevant information, including the predefined configuration data 106 and the customer specified elections, is retrieved and available for processing. In addition, the design table information can be used to derive correct customer features and associated engineering part definitions from the product template definition 316 to create the customer specific end item 1014. Based upon this information, at 1310, the definition of the features of the commodity is processed. At 1312, the interfaces of the commodity are evaluated and processed to define the commodity for the design configuration 102. At 1314, the information for the particular commodity is output. For example, the commodity data can be written to the design configuration files (e.g., the bill of materials, custom design table or customer specific end item).

At step 1316, the loop ends and the process returns to step 1302, where either the next commodity is processed or, if all commodities have been processed, the process continues at step 1318. At step 1318, the design configuration 102 is output.

In an aspect, the resulting design configuration 102 is tested and upon acceptance, used in automated production and manufacture. As discussed above, the design configuration 102 may undergo evaluation and test to ensure quality of the design and trigger adjustment of the predefined configuration data 106, if necessary. After test or evaluation, the design configuration 102 is available for customer review, production or any other suitable purposes. The design configuration 102 is a standardized description of the customized design. Various tools, processes and systems can utilize this standardized design configuration 102 to facilitate production of the product. For example, the WBS identifiers incorporated in the design configuration 102 facilitate ordering or manufacture of the necessary parts for assembly.

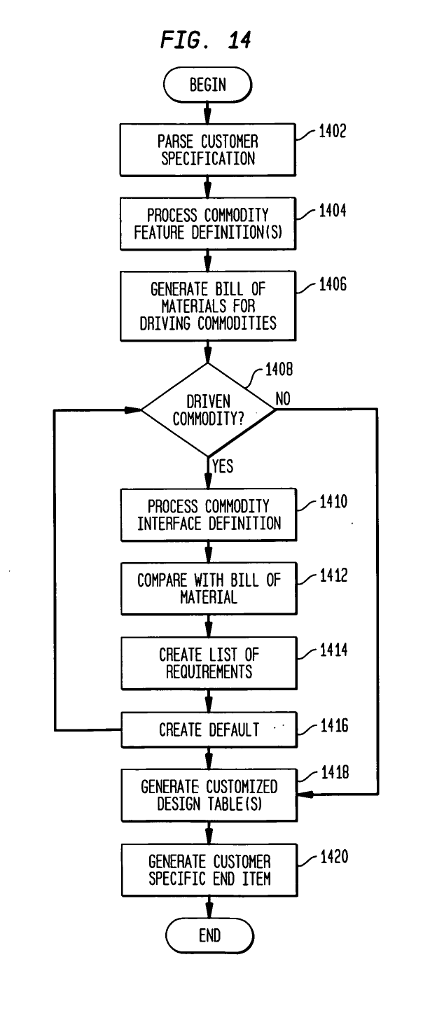

Turning now to FIG. 14, another embodiment of a configuration process is illustrated. At step 1402, the customer specification 104 is obtained and parsed to determine customer selected options for the design configuration 102. At step 1404, the configuration generation component 1008 processes each commodity feature definition 110, or commodity logic tree, in turn. By processing the set of commodity feature definitions 110, the configuration generation component 1008 obtains information regarding the processing requirements for each commodity of the product. The sequence for processing the individual commodity feature definitions 110 is determined based upon the product hierarchy definition 108.

Based upon the commodity logic and data obtained from the commodity feature definitions 110, in combination with the customer data from the customer specification 104, the configuration generation component 1008 generates one or more bills of materials 1010 at step 1406. In an aspect, a bill of materials 1010 is produced for each of the driving commodities selected in the customer specification 104. As used herein, the term “driving commodity” indicates that the features of the particular commodity drive or control aspects of other commodities. The logic that describes these relationships is obtained through processing of the commodity feature definitions 110 and/or the commodity interface definitions 112.

Beginning at step 1408, the configuration generation component 1008 enters a loop to process each driven commodity based upon the driving commodity. At 1408, a determination is made as to whether there are additional driven commodities, where a “driven commodity” is a commodity whose requirements are effected by a driving commodity. For example, in an airplane interior, the particular type of ceiling panel for a location may be driven by a commodity such as a closet, positioned beneath that ceiling panel. The order of processing of driven commodities may be determined using the product hierarchy definition 108. If driven commodities remain to be processed, the process continues at step 1410, where the commodity interface definition 112 for the selected driven commodity is processed by the configuration generation component 1008. For example, the commodity interface definition 112, or interface logic tree, for a ceiling panel is consumed or processed by the configuration generation component 1008. At 1412, the information obtained from the commodity interface definition 112 is compared with the bill of materials 1010 for the driving commodity or commodities. Based upon this comparison and the features and locations of each driving commodity (e.g. a closet), the configuration generation component 1008 generates a list of requirements at step 1414. For example, the configuration generation component 1008 can create a list of ceiling panel requirements required for interface with the closet driving commodity. In an aspect, this list of requirements may be thought of as a type of mini customer specification. The process for deriving these requirements may be similar to the process used to derive driving commodity requirements from the customer specification 104. Upon completion of creation of this list of requirements based upon all of the driving commodities, the configuration generation component 1008 will have all of the data for specification of the driven commodities to support of the driving commodities of the product.

At step 1416, default commodity information is provided for any driven commodities not controlled by the driving commodities. For example, any ceiling location not constrained by placement of a closet or other driving commodity would be assigned a generic or default specification. If more driving commodities are added, these generic driven commodities may be swapped out or replaced based upon the driving commodity requirements. The process continues by returning to step 1408, where the next driven commodity is processed, if any. If no driven commodities remain for processing, the process continues at step 1418.

At 1418, customized design tables 1012 are generated based upon the requirements for each commodity as defined in the bill of materials 1010, and the list of requirements for driven commodities previously generated. Finally, the customer specific end item 1014 is derived from the customized design tables 1012 and bill of materials 1010 at step 1420.

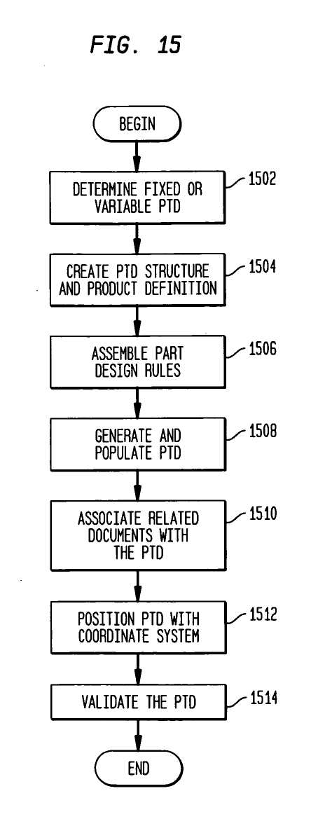

Referring to FIG. 15, an exemplary method for creating a product template definition or PTD 316 is illustrated. In an aspect, during pre-design, a product template definition 316 is created for each commodity, where a product template definition 316 represents all possible permutations of a commodity and is based at least in part upon the commodity feature data 304. To create a product template definition 316, at step 1502, a determination is made as to whether the commodity for which the PTD 316 is to be created is fixed or adaptable based upon the associated commodity feature data 304. An adaptable PTD 316 is a commodity component assembly that can be positioned in multiple locations, as defined by the customer specification 104. Returning to the airplane example, adaptable PTDs include closets and lavatories, while fixed PTDs 316 would include ceilings and sidewalls. In an aspect, the PTD coordinate system can reflect and be consistent with the manner in which the commodity is located within the product. In a further aspect, some commodities can be either a fixed or adaptable, in which case separate fixed and adaptable PTDs 316 can be generated for the same commodity. In the airplane example, closet and partition commodities can be either fixed or adaptable.

At step 1504, the PTD product structure and associated product definition are created. In an aspect, the PTD product structure is created in phases, gradually adding more detail and more basic elements and information. For example, the initial PTD structure can be created, gradually completed, and finally populated with parts and assemblies. During initial creation, the PTD product structure, which may be implemented as a logic tree, can describe in graphical form the full array of features related to the commodity represented by the PTD. The initial structure is derived from the commodity feature data 304 and the commodity interface data 312. Additional product definition information is then added to the product structure (e.g., DNOs, CAs). Next, parts and assemblies are associated with the PTD commodity structure. Associating the parts and assemblies to the completed commodity PTD product structure identifies the parts/assemblies available to create the PTD.

At step 1506, part design rules for the parts of the commodity PTD are assembled. Such rules can include commodity specific design rules and standards or company specific design standards that apply to the assemblies of the commodity.

Next at 1508, the PTD product structure and associated data are used to generate and populate a PTD. In an aspect, the PTD product structure and data can be used to create a PTD utilizing ENOVIA. This may be accomplished by first creating the first-top level PTD component assembly under the root class of the commodity. The commodity product structure and its associated parts and assemblies are then used to populate the PTD in ENOVIA. The commodity feature data 304, or variability matrix, may be used as a reference. Existing applicable component assemblies and their associated product structure and parts are also brought into the PTD to complete the PTD. Reuse of part definition within the PTD is also possible. In addition, a component assembly requirement model (CARM) can be added into the PTD. The CARM within the PTD can be a variable CARM, where a variable CARM is an assembly requirement model that assembles the appropriate parts required for selected features. In an aspect, the CARM is defined to contain all joint definitions, standard parts and notes necessary to support all permutations of the commodity features.

At step 1510, related documents are associated with the PTD 316 for use during the configuration process. For example, the commodity feature data 304, commodity interface data 312, commodity feature definition 110, and design table 308 may all be associated with the PTD 316 to provide sufficient commodity information for configuration of the commodity during generation of a design configuration 102.

Next at step 1512, the PTD 316 is positioned within a coordinate system for the product. The PTD 316 may be aligned in either the product or local coordinate system depending upon the commodity and how it is instanced.

At step 1514, the PTD 316 enters validation testing to determine whether or not the PTD 316 is valid. The PTD 316 should be validated to ensure that the PTD 316 can successfully support the creation of a customer specific end item 1014. In an aspect, the PTD 316 can be validated for completeness and accuracy against a test design table 308 (of an existing configuration) or a released design configuration 102 (from the customer specification 104). The PTD 316 part count and bill of materials 1010 generated by the configuration system 100 is then validated against the existing/released design configuration 102.. The commodity PTD product structure from the PTD requirements package can be used to validate for correct and complete part to part relationships, part locations, and general integration. The commodity logic tree (derived from the variability matrix) can also be used as a general guideline to validate the PTD features for completeness.

If the PTD 316 fails validation, the PTD 316 may be revised, recreated and tested again. In addition, if the product or customer desires change over time, the PTD 316 may be revised and rebuilt. Any supplemental design work required at customer implementation shall be added to the PTD 316. For example, the PTD 316 can be revised to add a new part or assembly that was not in the existing PTD 316 but was manually added to the original customer specific configuration.

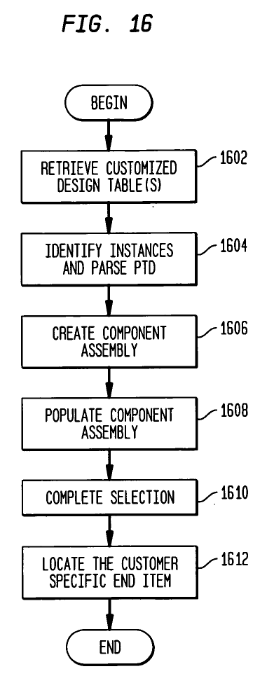

Referring now to FIG. 16, an exemplary methodology for generating a customer specific end item 1014 is illustrated. At step 1602, one or more customized design tables 1012 are retrieved and part information, such as WBS numbers, is obtained by the customized design tables 1012. At 1604, instances are identified from the PTD for the relevant commodity, and the PTD is parsed to identify and collect all relevant part instances.

At step 1606, a new component assembly (CA) is created and the instances collected above are placed in the new component assembly. At step 1608, the newly created component assembly is populated. This can be accomplished by identifying parts with more than one selectable feature and copying in a part for each into the component assembly. All unselected features can be removed based upon the customer specification 104. Only those parts actually used are included in the component assembly.

At step 1610, feature selection is completed. In an aspect, new instances of parts that were specified for use in the design table are created. These new instances are created from existing part references in ENOVIA based upon the design table 308 data collected above. Finally, at step 1612, the coordinates of the customer specific end item 1014 are located based upon product coordinates.

While various embodiments have been described above, it should be understood that the embodiments have been presented by way of example only, and not limitation. It will be understood by those skilled in the art that various changes in form and details may be made therein without departing from the spirit and scope of the subject matter described herein and defined in the appended claims. Thus, the breadth and scope of the present invention should not be limited by any of the above-described exemplary embodiments, but should be defined only in accordance with the following claims and their equivalents.

What is claimed is:

1. A method for generating a design configuration for a product, comprising:
obtaining a custom specification that describes at least one option for the product;
obtaining predefined configuration data that comprises:
a commodity feature definition that describes a plurality of commodities associated with the product;
a commodity interface definition that describes interface requirements among said plurality of commodities;
a design table that associates said commodity feature definition and said commodity interface definition for a commodity; and
a hierarchy of said plurality of commodities;
generating the design configuration as a function of said custom specification and said predefined configuration data, wherein said hierarchy of said plurality of commodities controls order in which said plurality of commodities are applied to said product for automatic generation of the design configuration and said commodity interface definition with said design table ensure coordination among said plurality of commodities.

2. The method of claim 1, further comprising:
reviewing the design configuration for conformance to an engineering requirement; and
updating said predefined configuration data based at least in part upon nonconformance of said design configuration.

3. The method of claim 1, further comprising:
obtaining a second custom specification; and
generating a second design configuration as a function of said second custom specification and said predefined configuration data, wherein said hierarchy of said plurality of commodities controls order in which said plurality of commodities are applied to said product for automatic generation of said second design configuration and said commodity interface definition ensures coordination among said plurality of commodities.

4. The method of claim 1, wherein said commodity feature definition is a commodity logic tree.

5. The method of claim 1, wherein said commodity interface definition is an interface logic tree.

6. The method of claim 1, wherein said hierarchy of said plurality of commodities is a product logic tree.

7. The method of claim 1, the design configuration is a standardized format suitable for use with product management software.

8. The method of claim 1, further comprising:
generating said commodity feature definition;
generating said commodity interface definition; and
generating said hierarchy of said plurality of commodities.

9. The method of claim 1, wherein said design configuration comprises:
a bill of materials that specifies the product at the feature level;
at least one customized design table based at least in part upon said design table and said custom specification; and
a customer specific end item that describes the product.

10. The method of claim 9, wherein said predefined configuration data further comprises a product template definition represents all possible permutations of a commodity of said plurality of commodities and said customer specific end item is derived at least in part from said product template definition.

11. A method for generating a design configuration for an aerospace product, comprising:
obtaining a custom specification that describes at least one option for the aerospace product;
obtaining predefined configuration data that comprises:
a commodity feature definition that describes a plurality of commodities associated with the aerospace product;
a commodity interface definition that describes interface requirements among said plurality of commodities;
a design table that associates said commodity feature definition and said commodity interface definition for a commodity; and
a hierarchy of said plurality of commodities; and
generating the design configuration as a function of said custom specification and said predefined configuration data, wherein said hierarchy of said plurality of commodities controls order in which said plurality of commodities are applied to said product for automatic generation of the design configuration and said commodity interface definition with said design table ensure coordination among said plurality of commodities.

12. The method of claim 11, wherein said plurality of commodities includes a component of an airplane interior and the design configuration specifies an airplane interior.

13. The method of claim 11, wherein said commodity feature definition is a commodity logic tree.

14. The method of claim 11, wherein said commodity interface definition is an interface logic tree.

15. The method of claim 11, wherein said design configuration comprises:
a bill of materials that specifies the product at the feature level;
at least one customized design table based at least in part upon said design table and said custom specification; and
a customer specific end item that describes the product.

16. The method of claim 15, wherein said predefined configuration data further comprises a product template definition represents all possible permutations of a commodity of said plurality of commodities and said customer specific end item is derived at least in part from said product template definition.

17. A system that facilitates automatic generation of a configuration for a product, comprising:
a product hierarchy that specifies a hierarchy of a plurality of commodities for the configuration of the product;
an interface logic tree that specifies interface requirements for said plurality of commodities;
a plurality of commodity logic trees, wherein each of said plurality of commodity trees specifies one of said plurality of commodities; and
a configuration component that generates the configuration as a function of a customer selection, said product hierarchy, said interface logic tree, and said plurality of commodity logic trees.

18. The system of claim 17, further comprising:
a plurality of design tables that associate each of said plurality of commodity trees and said interface logic tree for said plurality of commodities; and
a product template definition that represents permutations of a commodity,
wherein the configuration is generated as a function of said plurality of design tables and said product template definition.

19. The system of claim 18, wherein the configuration is comprised of:
a plurality of custom design tables based at least in part upon said plurality of design tables and customer specifications;
a customer specific end item derived at least in part from the plurality of design tables and said product template definition.

20. The system of claim 17, wherein said plurality of commodities includes a component of an airplane interior and the design configuration specifies an airplane interior.
